(19) United States
(12) Patent Application Publication
(10) Pub. No.: US 2016/0033111 A1
(43) Pub. Date: Feb. 4, 2016

(54) ELECTRIC LIGHT FIXTURE

(71) Applicant: Udo THRAEN, Balve (DE)

(72) Inventor: Udo THRAEN, Balve (DE)

(21) Appl. No.: 14/749,759

(22) Filed: Jun. 25, 2015

(30) Foreign Application Priority Data
Aug. 4, 2014 (DE) 202014103605.9

(51) Int. Cl. F21V 7/22; F21V 13/04; F21V 15/01; F21V 7/00

(52) U.S. Cl. CPC F21V 7/22; F21V 7/0066; F21V 13/04; F21V 15/01; F21Y 2105/001

(57) ABSTRACT

An electric light fixture has at least a housing with a light-emitting aperture, a glare ring surrounding the light-emitting aperture, LEDs positioned in the housing as light sources and a reflector for the reflection and, if necessary, focusing of the light produced by the LEDs, as well as a cable to the power supply. The LEDs are positioned at or on the side of the glare ring facing the housing, so that the beam of light from the LEDs is directed at the reflector that is positioned on or in the housing as a dome over the glare ring and the light-emitting aperture, such that the reflector is designed to be reflecting and substantially non-mirroring.

Some embodiments concern an electric light fixture having at least a housing with a light-emitting aperture, a glare ring surrounding that aperture, LEDs positioned in the housing as a light source and a reflector for the reflection and, if necessary, the focusing of the light produced by the LEDs, as well as a cable to the power supply.

Such electric light fixtures are well known in the state of the art and are widely distributed in the market. These lights come in many design forms such as, for example, recessed ceiling and wall lights, wall mounted lights, recessed floor lights with covering glass, pendant lights, standard lamps and table lamps, as well as being used as spotlights where necessary.

The electric light fixture's design is thus determined according to its desired purpose.

With the known state-of-the art electric light fixtures of the type mentioned at the start it is disadvantageous that the reflector is usually designed with a mirroring effect, so that the LEDs are visible to an observer as a light source by looking through the light-emitting aperture. This is often undesired, and deters potential buyers from purchasing electric light fixtures fitted with LEDs as their light source.

Because of the state of the art mentioned at the beginning, the purpose of some embodiments is to improve electric light fixtures of the type initially mentioned so that, to the observer, the LEDs are invisible as a light source; an electric light fixture of this kind also produces an aesthetically pleasing impression on the consumer.

In order to solve this problem, some embodiments propose that the LEDs are positioned at or on the side of the glare ring facing the reflector, so that the beam of light from the LEDs is directed at the reflector that is positioned on or in the housing as a kind of dome over the glare ring and the light-emitting aperture, whereby the reflector is designed to be strongly reflecting and non-mirroring.

In particular, because the reflector is not designed with a mirroring effect, it is not possible for an external observer to perceive the LEDs optically by looking through the light-emitting aperture. The LEDs positioned on a glare ring inside the housing thus shine against the non-mirroring, and thereby strongly reflecting, reflector which in turn reflects the light produced into the environment through the light-emitting aperture. An extremely homogeneous light emission through the light-emitting aperture is produced by the positioning of the LEDs on the glare ring.

The glare ring can at the same time be designed as an individual component or as a part of the housing. Such an electric light fixture is regarded by the user as especially aesthetic, because the LEDs are not, for example, so optically noticeable as to disturb the overall optical impression.

It can here preferably be provided that the reflector has a white, non-mirroring coating.

An extremely homogeneous light emission, felt by the user to be very pleasant, is on the one hand produced by a white, non-mirroring reflector coating and, on the other hand, prevents the user from a view of the LEDs positioned on the glare ring.

If preferred it can be provided that the reflector has a colored, non-mirroring coating.

The choice of color of the coating can in this case be made according to the user's wish, so that here too the LEDs are not visually perceivable by the user.

Where especially preferred, it can further be provided that all the LEDs are positioned on a common sinker ring, such that the sinker ring is connected by a cable to the power supply.

In positioning all the LEDs on a common sinker ring, it is merely necessary to connect the sinker ring to an external power supply, so that further wiring inside the electric light fixture is no longer required.

It can furthermore preferably be provided that a detachable or non-detachable lens is positioned in the light-emitting aperture.

The positioning of a lens in the light-emitting aperture on the one hand makes possible the use of the electric light fixture as a recessed floor light, or even as a recessed wall light, as the use of the lens especially prevents any reaching inside the light. In addition, the angle of light emission can also be varied by using a lens. The electric light fixture's intended purpose is thus correspondingly augmented by the use of a lens.

Where preferred it can also be especially provided that the dome type reflector is completely covered by housing components.

Alternatively it can, where particularly preferred, be provided that the dome type reflector is partially covered or overlaid by housing components.

Depending on the desired optical configuration of the electric light fixture, the dome type reflector can thus be completely or partially overlaid or covered by housing components, so that the dome shaped housing is not positioned visible to an external observer. As a result, the electric light fixture can be manufactured in all types of design, so that the operation and purpose of the electric light fixture are in turn enhanced.

In particular, it can where preferred be especially provided that the light-emitting aperture has a shape differing from the circular shape, for example an elliptical shape, or a square, rectangular or oval shape.

Because of this the light's field of application is also extended by adapting the shape to, for example, other shapes and bodies in its environment.

Finally, it can where especially preferred be provided that the cable to the power supply is positioned out of sight inside the housing.

Because of this it is also ensured that absolutely no components such as, for example, current carrying wires, can negatively affect the light's overall aesthetic impression.

Some embodiments are shown by way of example only in the diagrams, and are more fully described below.

The following are shown:

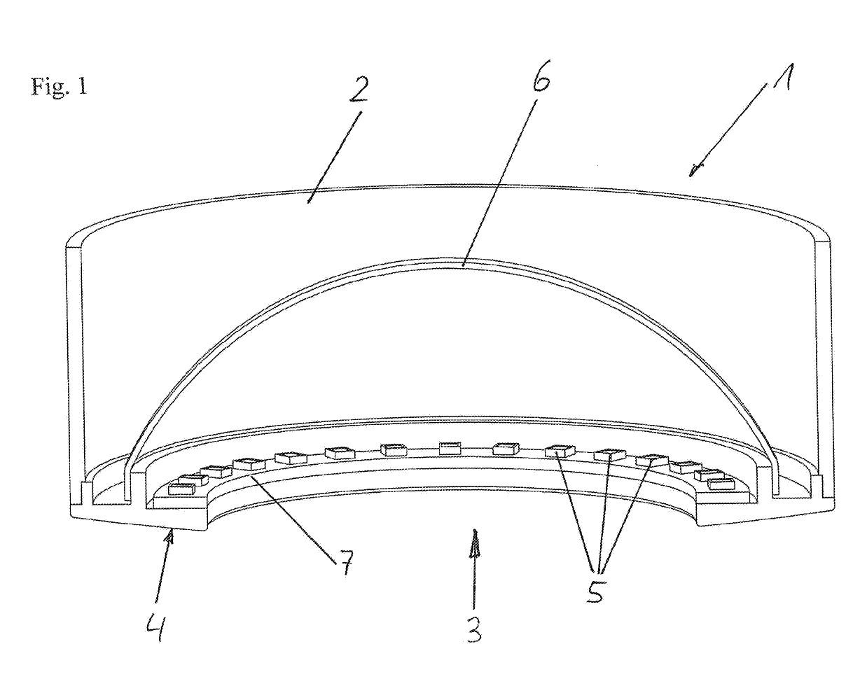

FIG. 1, a first embodiment in cross-section, seen obliquely from above;

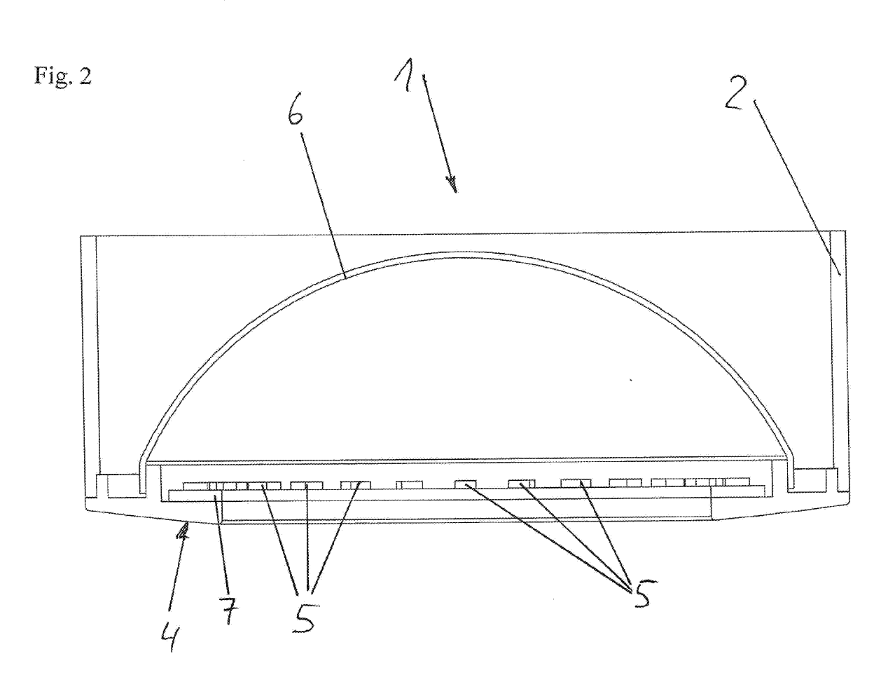

FIG. 2, the same, seen in cross-section;

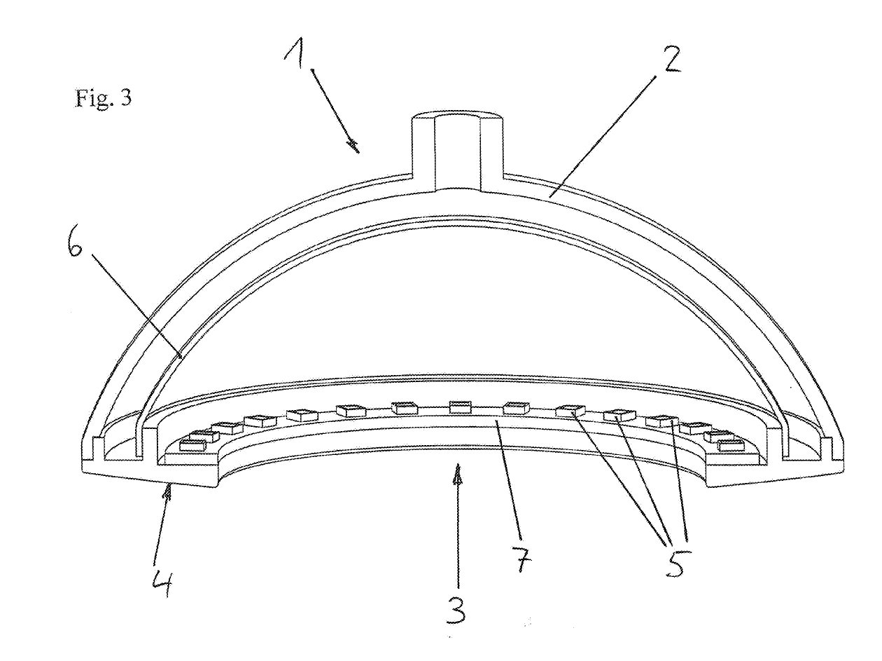

FIG. 3, a second embodiment in cross-section, seen obliquely from above;

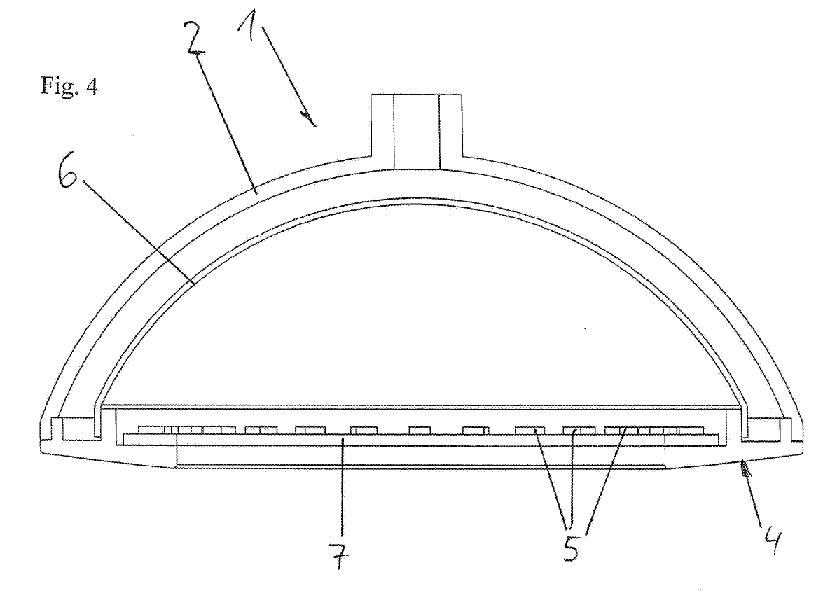

FIG. 4, the same, seen in cross-section.

An electric light fixture 1 is shown in cross-section in the diagrams. The electric light fixture 1 has at least one housing 2 with a light-emitting aperture 3, a glare ring 4 surrounding that light-emitting aperture 3, LEDs 5 positioned as light sources in the housing 2 and a reflector 6. The reflector 6 serves here for the reflection and, if necessary, focusing of the light produced by the LEDs 5. The electric light fixture also has a cable to the power supply, not shown in the diagrams.

According to some embodiments, the LEDs 5 inside the housing 2 are positioned on the side of the glare ring 4 facing the reflector 6. The beam of light from the LEDs 5 is thereby directed to the reflector 6. The reflector 6 is positioned on the housing 2, in the form of a dome over the glare ring 4 and the light-emitting aperture 3. The reflector 6 is designed to be strongly reflective but non-mirroring. By this means no visual perception of the LEDs 5 is possible to the user or observer by looking through the light-emitting aperture 3 of the electric light fixture 1. The aesthetic impression of the electric light fixture 1 according to some embodiments is thus extremely pleasing, in spite of the use of LEDs 5 to produce the light, because neither the consumer nor the user desires optical perception of the LEDs 5. In addition, by the positioning of the LEDs 5 on the glare ring 4, a homogeneous distribution of light is achieved that is given off into the environment by the reflector 6 through the light-emitting aperture 3.

In the design example the reflector 6 has a white coating. By this means a homogeneous production of light, which is felt by the user to be very pleasant, is made possible.

A color coating of the reflector can also be provided if necessary, according to the user's individual requirements.

In the design example, all the LEDs 5 are positioned on a common sinker ring 7. The sinker ring 7 can be connected to the power supply by a cable, not shown in the diagrams.

In order to extend the range of application of an electric light fixture 1 of this type, in particular to its use as a recessed floor or wall light, or in order also to vary the light emission angle according to the area to be illuminated, a detachable or non-detachable lens, not shown in the diagrams, can be positioned in the light emission aperture 3. In the case of the detachable positioning of a lens, such a lens can, for example, be exchanged later in a quick and simple way for a lens with a different light emission angle or, for example, a colored lens.

Depending on the design shape of the electric light fixture 1, the dome type reflector 6 can be completely or partially overlaid or covered by housing components 2 or by the housing 2.

In other design examples, not shown in the diagrams, the light emission aperture 3 has a shape varying from the ring shape.

This can for example be an elliptical shape, or a square, rectangular or oval shape.

In order not to disturb the overall aesthetic impression, the cable to the power supply is positioned inside the housing 2, out of sight of the observer.

The invention is not restricted to the design examples, but is widely variable within the framework of the disclosure.

### REFERENCE LIST

1 Electric light fixture

2 Housing

3 Light-emitting aperture

4 Glare ring

5 LEDs

6 Reflector

7 Sinker ring

1. An electric light fixture, having at least a housing with a light-emitting aperture, a glare ring surrounding the light-emitting aperture, LEDs positioned in the housing as light sources and a reflector for the reflection and, if necessary, focusing of the light produced by the LEDs, as well as a cable to the power supply, wherein the LEDs are positioned at or on the side of the glare ring facing the housing, so that the beam of light from the LEDs is directed at the reflector that is positioned on or in the housing as a dome over the glare ring and the light-emitting aperture, such that the reflector is designed to be reflecting and substantially non-mirroring.

2. The electric light fixture defined in claim 1, wherein the reflector has a white, substantially non-mirroring coating.

3. The electric light fixture defined in claim 1, wherein the reflector has a colored, substantially non-mirroring coating.

4. The electric light fixture defined in claim 1, wherein all the LEDs are positioned on a common sinker ring, such that the sinker ring is connected to the power supply by a cable.

5. The electric light fixture defined in claim 1, wherein a detachable or non-detachable lens is positioned in the light-emitting aperture.

6. The electric light fixture defined in claim 1, wherein the dome reflector is completely overlaid by housing components.

7. The electric light fixture defined in claim 1, wherein the dome reflector is partially covered or overlaid by housing components.

8. The electric light fixture defined in claim 1, wherein the light-emitting aperture has a shape differing from the ring shape, for example an elliptical shape, or a square, rectangular or oval shape.

9. The electric light fixture defined in claim 4, wherein the cable to the power supply is positioned out of sight inside the housing.
